(19) United States
(12) Patent Application Publication
(10) Pub. No.: US 2006/0139839 A1
(43) Pub. Date: Jun. 29, 2006

(54) Constant current relay drive circuit

(75) Inventors: Koichi Sato, Anjo-city (JP); Koichi Tsukada, Okazaki-city (JP); Fukuo Ishikawa, Kariya-city (JP); Hirofumi Mokuya, Kariya-city (JP)

Correspondence Address: POSZ LAW GROUP, PLC, 12040 SOUTH LAKES DRIVE, SUITE 101, RESTON, VA, 20191, US

(73) Assignees: ANDEN CO., LTD., Anjo-city (JP); DENSO CORPORATION, Kariya-city (JP)

(21) Appl. No.: 11/300,288

(22) Filed: Dec. 15, 2005

(30) Foreign Application Priority Data
Dec. 28, 2004 (JP) 2004-379805

(51) Int. Cl. H01H 47/00

(52) U.S. Cl. 361/140

(57) ABSTRACT

A relay drive circuit includes a power supply circuit for producing a constant voltage, an initial energization circuit for performing an initial energization such that a power supply provides an initial energizing voltage to a relay, a low-holding energization circuit for performing a low-holding energization such that the constant voltage provides a constant current to the relay after the initial energizattion. Due to the low-holding energization, the relay contact can be firmly held even when relay coil resistance changes. The constant voltage for performing the low-holding energization is lower than the power supply voltage so that power consumption and heat generation can be reduced.

### CROSS REFERENCE TO RELATED APPLICATION

This application is based on and incorporates herein by reference Japanese Patent Application No. 2004-379805 filed on Dec. 28, 2004.

### FIELD OF THE INVENTION

The present invention relates to a constant current relay drive circuit.

### BACKGROUND OF THE INVENTION

A conventional relay drive circuit drives a relay by a constant voltage, thus holding a relay contact in a closed position. However, in such a relay drive circuit, a holding force for holding a relay contact in a closed position depends on magnetomotive force (MMF) of a relay. The magnetomotive force is determined as a product of the number of turns of a relay coil and the amount of electric current flowing through the relay coil.

As understood from FIG. 8, which shows relationships between ambient temperature of the relay and magnetomotive force of the relay, and between the ambient temperature and a relay coil resistance, when the ambient temperature increases, the relay coil resistance increases.

In this figure, magnetomotive force P represents minimum magnetomotive force required for the relay contact to be held in a closed position. A constant voltage of 6 volts is needed to generate the magnetomotive force P, when the ambient temperature reaches the maximum temperature of 120° C. However, when the ambient temperature does not reach the maximum temperature, the constant voltage of 6 volts generates excessive magnetomotive force, thereby resulting in loss of power.

When the constant voltage is reduced to 4.3 volts, the excessive magnetomotive force is reduced accordingly. However, when the ambient temperature exceeds a threshold temperature T, the constant voltage of 4.3 volts cannot generate the magnetomotive force P so that the relay contact is opened due to lack of magnetomotive force.

The present applicant suggests a relay drive circuit for holding a relay contact in a closed position by a constant current. The constant current relay drive circuit is disclosed in US 2005/0135040A1 corresponding to JP-A-2005-197212.

As described above, the magnetomotive force of a relay is determined by the product of the number of turns of a relay coil and the amount of an electric current flowing through the relay coil. In the constant current relay drive circuit, therefore, the magnetomotive force is held constant as shown by a bold solid line in FIG. 8, even when the relay coil resistance increases as a result of an increase in ambient temperature of the relay. Thus, the constant current relay drive circuit prevents the relay contact from being opened without generating excessive magnetomotive force.

The constant current relay drive circuit does not include a power supply used exclusively for providing a constant current to the relay in order to prevent increases in the size and the complexity of the circuit. To produce a voltage required for a relay contact to be held in a closed position, the constant current relay drive circuit uses voltage drop across a relay drive section having relay drive transistors, thereby providing a constant current to the relay. However, the voltage drop may be high so that power consumption and heat generation in the relay drive section may be increased.

### SUMMARY OF THE INVENTION

In view of the above-described problem, it is an object of the present invention to provide a constant current relay drive circuit that drives a relay by a constant current without increasing power consumption and heat generation.

A constant current relay drive circuit includes a constant voltage power supply circuit for producing a constant voltage from a power supply, an initial energization circuit for performing an initial energization such that the power supply provides an initial energizing voltage to a relay to hold a relay contact in a closed position, a low-holding energization circuit for performing a low-holding energization such that the constant voltage provides a constant current to the relay to hold the relay contact in the closed position even after the initial energizattion, and a control circuit for controlling the initial energization circuit and the low-holding energization circuit.

The constant current relay drive circuit drives the relay by the constant current. Therefore, even when relay coil resistance changes as a result of change in relay ambient temperature, the relay contact can be firmly held in a closed position.

The constant voltage for providing the constant current is lower than the power supply voltage. Therefore, power consumption and heat value can be reduced.

### BRIEF DESCRIPTION OF THE DRAWINGS

The above and other objectives, features and advantages of the present invention will become more apparent from the following detailed description made with reference to the accompanying drawings. In the drawings:

FIG. 1 is a circuit diagram of a relay drive circuit according to a first embodiment of the present invention;

FIG. 2 is a circuit diagram of a control circuit shown in FIG. 1;

FIG. 3 is a circuit diagram of a power supply circuit shown in FIG. 1;

FIG. 4 is a circuit diagram of a relay drive circuit according to a modification of the first embodiment;

FIG. 5 is a circuit diagram of a relay drive circuit according to a second embodiment of the present invention;

FIG. 6 is a circuit diagram of an initial energization circuit, a low-holding energization circuit, and a relay-off circuit shown in FIG. 5;

FIG. 7 is a circuit diagram of a control circuit shown in FIG. 5; and

FIG. 8 is a graph showing relationships between relay ambient temperature and relay magnetomotive force, and between the relay ambient temperature and relay coil resistance.

### DETAILED DESCRIPTION OF THE PREFERRED EMBODIMENTS

### First Embodiment

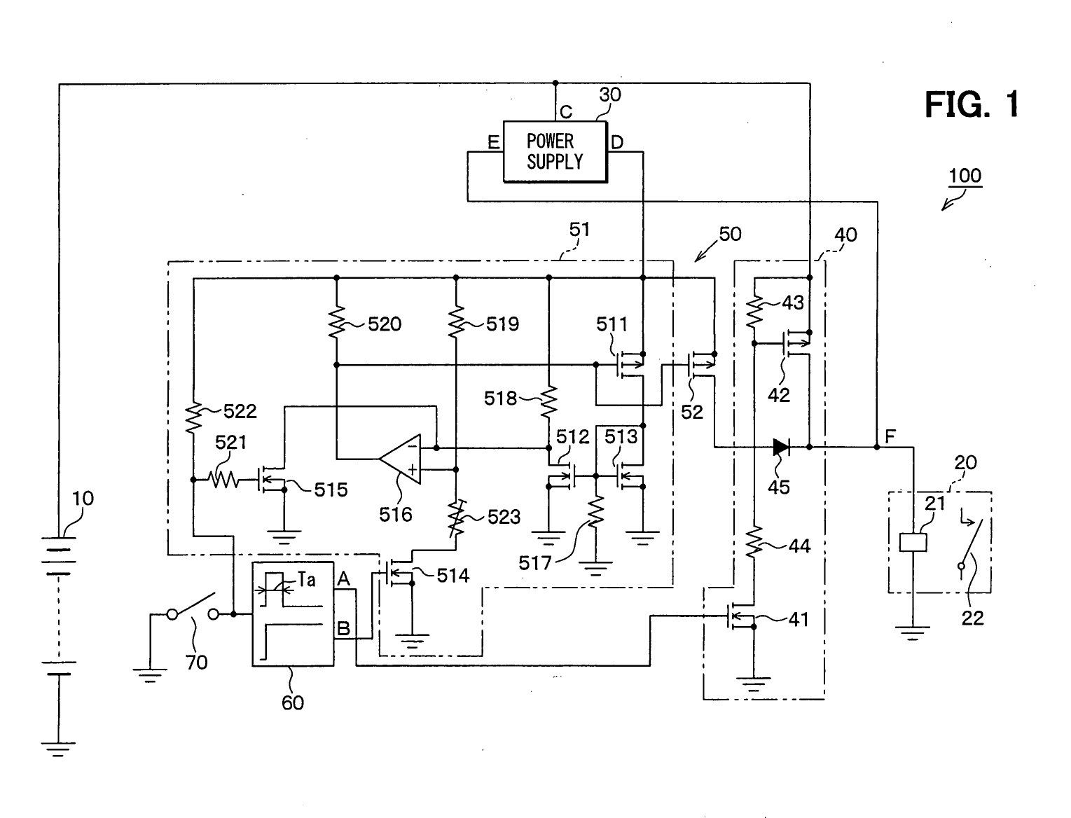

Reference is made to FIG. 1, which shows a circuit diagram of a relay drive circuit 100. The relay drive circuit 100 is for driving a relay 20 for energizing a load (i.e., vehicular headlight). The relay 20 has a relay coil 21 and a relay contact 22.

The relay drive circuit 100 includes a power supply circuit 30 for a low-holding energization, an initial energization circuit 40, a low-holding energization circuit 50, and a control circuit 60.

The power supply circuit 30 produces a constant voltage (e.g., 4 to 6.5 volts) lower than a voltage (12 volts) of a battery 10. The initial energization circuit 40 performs an initial energization such that the battery 10 provides an initial energizing voltage to the relay coil 21 to hold the relay contact 22 in a closed position. The low-holding energization circuit 50 performs the low-holding energization such that the constant voltage provides a constant current to the relay 20 to hold the relay contact 22 in a closed position. The control circuit 60 controls the initial energization circuit 40 in such a manner that the initial energization circuit 40 performs the initial energization for a predetermined time period Ta when an external input switch 70 is turned on. Further, the control circuit 60 controls the low-holding energization circuit 50 in such a manner that the low-holding energization circuit 50 performs the low-holding energization as long as the external input switch 70 stays ON.

The control circuit 60, the initial energization circuit 40, the low-holding energization circuit 50, and the power supply circuit 30 are each described below in detail with reference to FIGS. 1 to 3.

The control circuit 60 outputs a high-level signal through a terminal A for the predetermined time period Ta when the external input switch 70 is turned on, and outputs a high-level signal through a terminal B as long as the external input switch 70 stays ON.

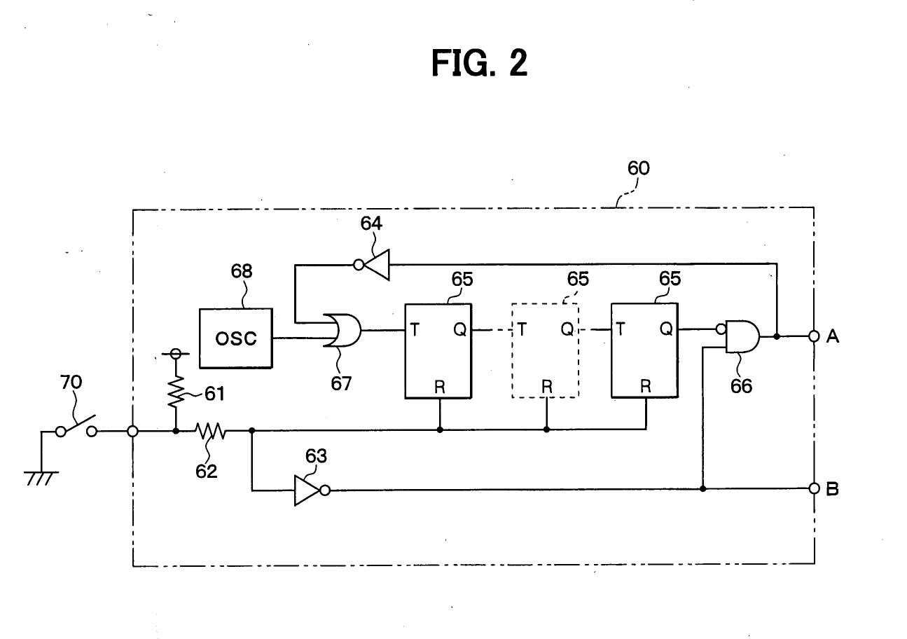

As shown in FIG. 2, the control circuit 60 includes resistors 61, 62, inverters 63, 64, counter circuits 65, an AND gate 66 having one inverting input terminal and one non-inverting input terminal, an OR gate 67, and an oscillator (OSC) 68.

When the external input switch 70 is turned on, the output of the inverter 63 becomes high so that a high-level signal is outputted through the terminal B. At the same time, all of the counter circuits 65 are released from the reset state. As of this time, the output of the last stage of the counter circuits 65 is still low. Therefore, a high-level signal and a low-level signal are provided to the non-inverting input terminal and the inverting input terminal of the AND gate 66, respectively, so that the AND gate 66 outputs a high-level signal through the terminal A. When the output of the AND gate 66 becomes high, the output of the inverter 64 becomes low. The low-level signal is provided to one of the input terminal of the OR gate 67. Thus, the oscillating signal of the OSC 68 is provided to the first stage of the counter circuits 65 through the OR gate 67 and counted by the counter circuits 65.

When each counter circuit 65 counts the respective set time (i.e., a predetermined number of the oscillating signals), the output of the last stage of the counter circuits 65 becomes high so that the output of the AND gate 66 becomes low. Therefore, the output of the inverter 64 becomes high. As a result of the high level output of the inverter 64, the OR gate 67 outputs a high level signal to the counter circuits 65 regardless of whether the OSC 68 outputs the oscillating signal. Thus, the counter circuits 65 do not count the oscillating signal.

In this way, when the external input switch 70 is turned on, the control circuit 60 outputs a high-level signal through the terminal A for the predetermined time period Ta counted by the counter circuits 65. In contrast, the control circuit 60 outputs a high-level signal through the terminal B as long as the external input switch 70 stays ON.

The initial energization circuit 40 includes an N-channel metal oxide semiconductor field-effect transistor (MOSFET) 41, a P-channel MOSFET 42, resistors 43, 44, and a diode 45. When the initial energization circuit 40 receives the high-level signal from the control circuit 60 through the terminal A, both MOSFET 42 and MOSFET 43 are turned on. Thus, the initial energization circuit 40 performs the initial energization such that the battery 10 provides the initial energizing voltage to the relay 20. As a result of the initial energization, the relay contact 22 is fully held in a closed position. The diode 45 prevents reverse flow of current.

The low-holding energization circuit 50 includes a reference constant current circuit 51 for producing a reference constant current and a P-channel MOSFET 52 for providing the constant current to the relay 20.

The reference constant circuit 51 includes a P-channel MOSFET 511, a pair of N-channel MOSFETs 512, 513 that construct a current mirror circuit, an N-channel MOSFET 514 that is switched on and off in accordance with the output signal from the terminal B of the control circuit 60, an N-channel MOSFET 515 for applying ground potential to an inverting input terminal of an operational amplifier 516 when the external input switch 70 stays OFF, the operational amplifier 516, and resistors 517-523. The resistor 523 is an adjusting resistor.

When the external input switch 70 is turned off, the MOSFET 515 is turned on so that the inverting input terminal of the operational amplifier 516 is grounded. Thus, the operational amplifier 516 outputs a high-level signal so that the MOSFET 511 is turned off.

Therefore, when the external input switch 70 is turned off, no current flows through the MOSFET 511. Further, both gates of the MOSFET 512 and the MOSFET 513 are grounded through the resistor 517 having high impedance. The resistor 517 ensures that the MOSFET 511 stays OFF, as long as the external input switch 70 stays OFF.

When the control circuit 60 outputs the high-level signal through the terminal B, the MOSFET 514 is turned on. The operational amplifier 516 controls the gate voltage of the MOSFET 511 in such a manner as to keep the non-inverting input terminal and the inverting input terminal at the same potential. In this case, if the mirror ratio of the current mirror circuit constructed by the MOSFET 512 and the MOSFET 513 is set to 1, the same amount of current flows through each MOSFET 512, 513.

When a current flows through the MOSFET 512, voltage appears at the connection point between the MOSFET 512 and the resistor 518. The voltage is applied to the inverting input terminal of the operational amplifier 516.

The resistor 519 and the resistor 523 divide a constant voltage outputted from the power supply circuit 30. The divided constant voltage is applied to the non-inverting input terminal of the operational amplifier 516.

As descried above, the operational amplifier 516 controls the gate voltage of the MOSFET 511 in such a manner as to keep the non-inverting input terminal and the inverting input terminal at the same voltage. Therefore, even when the current flowing through the MOSFET 511 changes, the operational amplifier 516 controls the gate voltage of the MOSFET 511 so as to compensate for the change. Thus, the current flowing through the MOSFET 511 is held constant.

The MOSFET 511 and the MOSFET 52 construct another current mirror circuit. If the current mirror ratio is set to N (e.g., 1000), the constant current flowing through the MOSFET 52 is N times the constant current flowing through the MOSFET 511. The N-times constant current flows through the relay 20, and thus the low-holding energization is performed. A voltage for performing the low-holding energization is produced by the power supply circuit 30 and equivalent to a release voltage by which the relay contact 22 can be held in a closed position after being fully closed once.

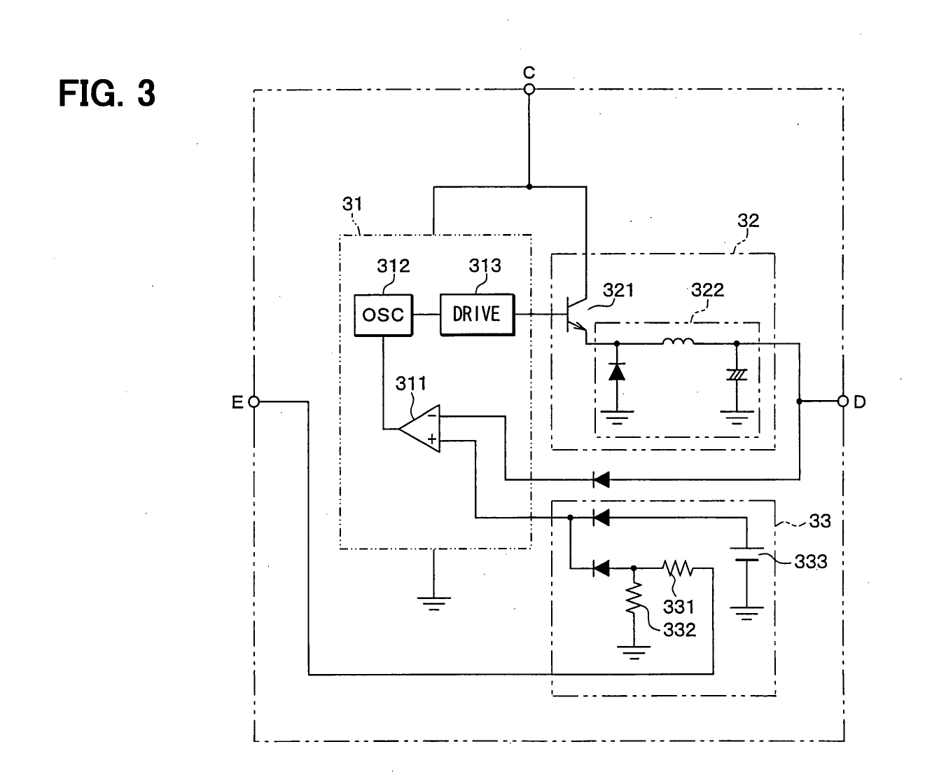

As shown in the FIG. 3, the power supply circuit 30 includes a power output control circuit 31, a power output circuit 32, a feedback voltage generation circuit 33, a power supply terminal C, a power output terminal D for the low-holding energization, and a feedback terminal E. The feedback terminal E is coupled to a point F at which the voltage of the relay coil 21 is monitored.

The power output control circuit 31 includes an operational amplifier 311, an oscillator (OSC) 312, and a drive circuit 313. The power output circuit 32 includes a transistor 321 and a smoothing circuit 322. The OSC 312 outputs an oscillating signal having a duty ratio that depends on the output voltage of the operational amplifier 311. The drive circuit 313 switches the transistor 321 on and off in accordance with the oscillating signal. The voltage of the battery 10 is provided by the switching of the transistor 321 and smoothed by the smoothing circuit 312. The smoothed voltage is outputted as a constant voltage through the power output terminal D. In short, the power supply circuit 30 is configured as a switching regulator circuit. The power supply circuit 30 may be configured as another circuit that provides a constant voltage with high efficiency.

The voltage of the relay coil 21 is applied to the feedback terminal E of the power supply circuit 30. The feedback voltage generation circuit 33 generates a feedback voltage equal to the sum of a reference voltage of a reference power supply 333 and a divided voltage provided by dividing the voltage of the relay coil 21 between resistors 331, 332. The feedback voltage is applied to the non-inversing input terminal of the operational amplifier 311. The operational amplifier 311 outputs a control voltage to the OSC 312 in order to control the OSC 312 in such a manner as to keep the constant voltage outputted from the power output terminal D and the feedback voltage at the same voltage.

Operations of the relay drive circuit 100 are described below.

When the external input switch 70 is turned on, the control circuit 60 outputs high-level signals through the terminal A during the predetermined time period Ta and through the terminal B as long as the external input switch 70 stays ON.

When the control circuit 60 outputs the high-level signal through the terminal A, the MOSFETs 41, 42 of the initial energization circuit 40 are turned on. Thus, the initial energization circuit 40 performs the initial energization such that the battery 10 provides an initial energizing voltage to the relay 20. As a result of the initial energization, the relay contact 22 is fully held in a closed position. At the same time, the low-holding energization circuit 50 generates a reference constant current and provides the reference constant current to the relay 20 through the MOSFET 52.

The output signal of the terminal A becomes low after the predetermined time period Ta from when the external input switch 70 is turned on. Then, the MOSFETs 41, 42 of the initial energization circuit 40 are turned off so that the initial energization of the relay 20 is finished. Thus, the energization of the relay 20 is switched from the initial energization to the low-holding energization. In the low-holding energization, the reference constant current circuit 51 generates the reference constant current and provides the reference constant current to the relay 20 through the MOSFET 52. The reference constant current continues to hold the relay contact 22 in the closed position, even after the initial energization is finished.

When the relay 20 is driven by the constant current, voltage of the relay coil 21 changes in accordance with a change in ambient temperature. Specifically, as shown in FIG. 8, when the ambient temperature increases, resistance of the relay coil 21 increases. Consequently, the voltage of the relay coil 21 increases because of the relationship such that the voltage is determined by the product of the current flowing through the relay coil 21 and the resistance of the relay coil 21.

Therefore, if the constant voltage outputted from the power supply circuit 30 is fixed, power shortage (saturation) may occur during the low-holding energization. To prevent the power shortage, the power supply circuit 30 performs a feedback control such that the voltage of the relay coil 21 is monitored and the constant voltage is outputted based on the monitored voltage. When the voltage of the relay coil 21 increases as a result of an increase in ambient temperature, the constant voltage outputted from the power supply circuit 30 increases due to the feedback control. Thus, the power shortage is prevented during the low-holding energization.

As described above, the relay drive circuit 100 includes the power supply circuit 30 for producing the constant voltage lower than the voltage of the battery 10. In the relay drive circuit 100, when the external input switch 70 is turned on, the initial energization circuit 40 performs the initial energization such that the battery 10 provides the initial energizing voltage to the relay 20 to fully hold the relay contact 22 in the closed position. After the predetermined time period Ta, the low-holding energization circuit 50 performs the low-holding energization such that the constant voltage provides the constant current to the relay 20 to hold the relay contact 22 in the closed position. Thus, the magnetomotive force of the relay 20 is held constant regardless of ambient temperature. Therefore, the relay contact 22 can be firmly held in a closed position.

Further, the constant voltage for providing the constant current is lower than the voltage of the battery 10. Therefore, power consumption and heat generation in the MOSFET 52 as the relay drive section can be reduced.

The power supply circuit 30 is configured as the switching regulator. Therefore, power consumption and heat generation can be reduced.

The power supply circuit 30 monitors the voltage of the relay coil 20 and outputs the constant voltage based on the monitored voltage. Therefore, even when the voltage of the relay coil 21 increases as a result of an increase in ambient temperature, power shortage in the low-holding energization can be prevented.

The control circuit 60 outputs the high-level signal through the terminal B, as long as the external input switch 70 stays ON. Alternatively, the control circuit 60 may be modified in such a way as to output the high-level signal through the terminal B from when the signal outputted through the terminal A changes from high to low to when the external input switch 70 is turned off.

The power supply circuit 30 monitors the voltage of the relay coil 21 and outputs the constant voltage based on the monitored voltage. In other words, the power supply circuit 30 increases the output constant voltage in accordance with an increase in resistance of the relay coil 21 using the voltage monitoring method. The power supply circuit 30 may detect an increase in resistance of the relay coil 21 using another method and output the constant voltage in accordance with the detected value.

For example, the power supply circuit 30 may detect a current flowing through the relay coil 21 by a current detection means (e.g., a shunt resistor connected in series with the relay coil 21) and output the constant voltage in accordance with the detected current.

For example, the power supply circuit 30 may detect ambient temperature of the relay coil 21 and output the constant voltage in accordance with the detected temperature.

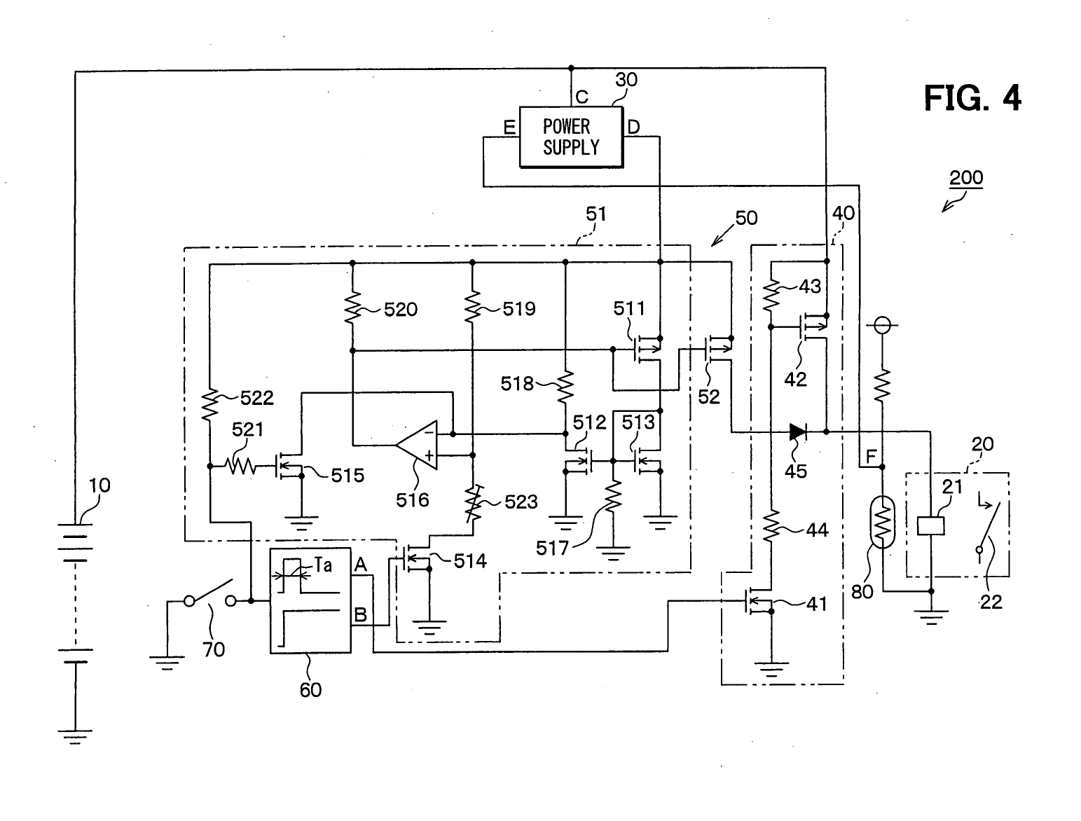

FIG. 4 shows a relay drive circuit 200 according to a modification of the relay drive circuit 100.

The relay drive circuit 200 has a thermistor 80 located near the relay coil 21. The thermistor 80 is used for detecting ambient temperature of the relay coil 21 so that the coil resistance may be detected indirectly. When the ambient temperature of the relay coil 21 increases, a voltage applied to the feedback terminal E of the power supply circuit 30 changes due to the thermistor 80. Thus, in the relay drive circuit 200, the power supply circuit 30 outputs a constant voltage in accordance with the ambient temperature of the relay coil 21.

### Second Embodiment

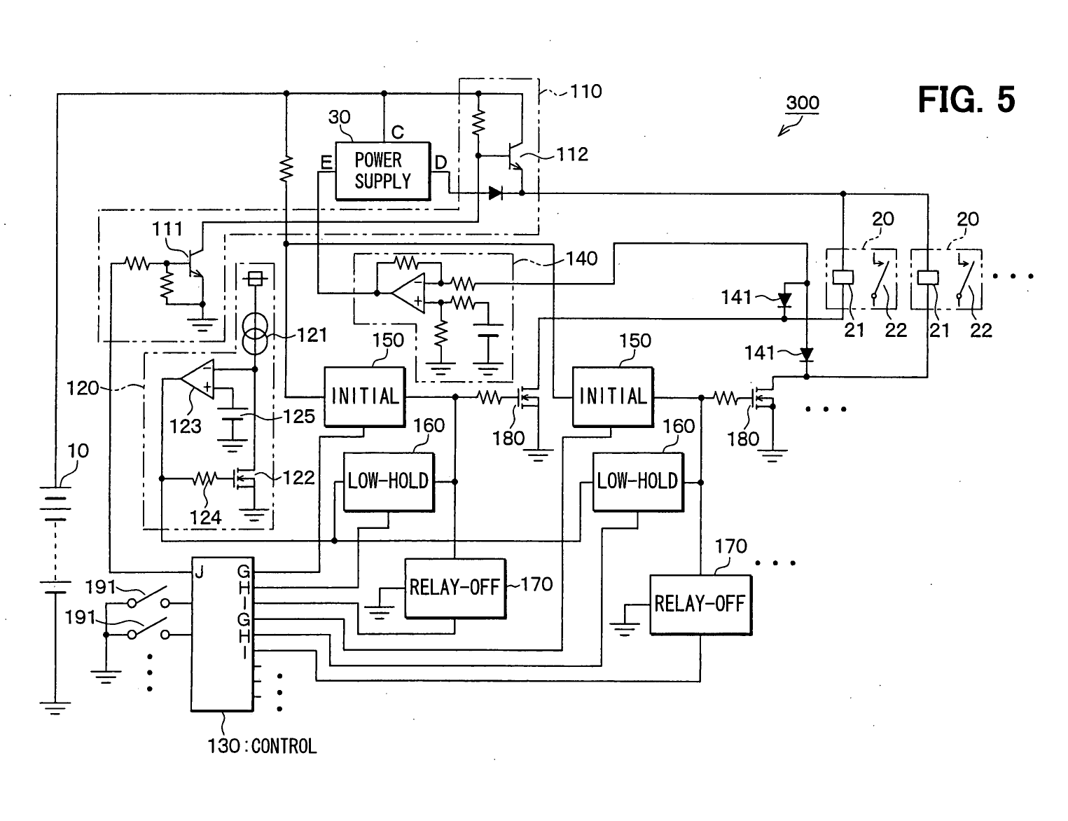

Reference is made to FIG. 5, which shows a circuit diagram of a relay drive circuit 300. The relay drive circuit 300 has multiple relay drive circuits (hereinafter, “drive channels”) for driving multiple relays 20.

The relay drive circuit 300 includes a power supply circuit 30, a power supply switching circuit 110, a reference constant current circuit 120, a control circuit 130, and a feedback circuit 140. The relay drive circuit 300 further includes, initial energization circuits 150, low-holding energization circuits 160, relay-off circuits 170, and relay drive transistors 180, which are provided to each drive channel of the respective relays 20.

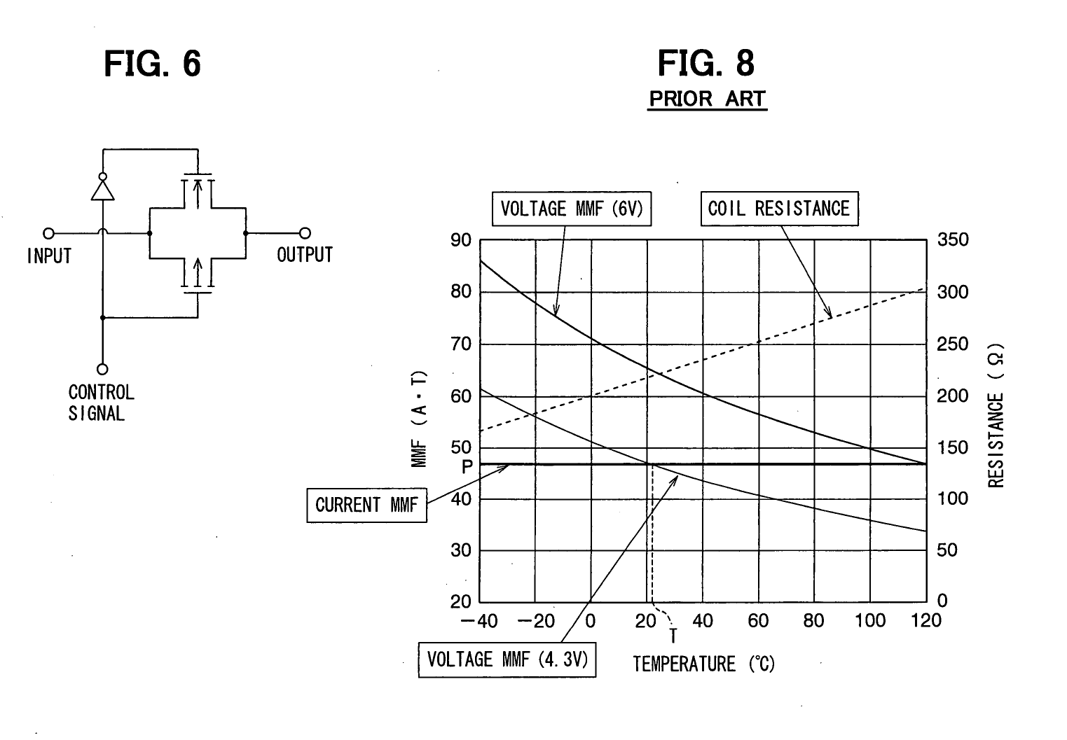

The initial energization circuit 150, the low-holding energization circuit 160, and the relay-off circuit 170 are each configured as an analog switch. When the circuits 150-170 receive a control signal of a high level from the control circuit 130, there is conduction between the input and the output of the respective circuits 150-170. As shown in FIG. 6, the analog switch has an N-channel MOSFET, a P-channel MOSFET, and an inverter, for example.

The reference constant current circuit 120 includes a constant current supply 121, an N-channel MOSFET 122, an operational amplifier 123, a resistor 124, and a reference power supply 125. The operational amplifier 123 controls the gate voltage of the MOSFET 122 in such a manner as to keep the drain voltage of the MOSFET 122 and a voltage of the reference power supply 125 at the same voltage. Thus, a reference constant current flows through the MOSFET 122.

The MOSFET 122 of the reference current circuit 120 and each MOSFET 180 of the respective drive channels constructs current mirror circuits. In the low drive energization, a constant current flowing through each MOSFET 180 is N times a constant current flowing through the MOSFET 122 in accordance with the mirror ratio of N (e.g., 1000).

The control circuit 130 has terminals G-J. The terminals G-I are provided to the respective drive channels of the relays 20. In contrast, the terminal J is shared among all the drive channels. External input switches 191 correspond to the respective drive channels of the relays 20.

When every relay 20 is not driven, i.e., every switch 191 stays OFF, the control circuit 130 outputs a high-level signal through every terminal I.

When at least one of the switches 191 is turned on, the control circuit 130 outputs a low-level signal through the terminal I corresponding to the turned-on switch 191. At the same time, the control circuit 130 outputs a high-level signal through the shared terminal J and the terminal G corresponding to the turned-on switch 191 for a predetermined time period Ta, i.e., until relay contacts 22 are fully closed. Then, after the predetermined time period Ta, the control circuit 130 outputs a low-level signal through the terminals J, G and a high-level signal through the terminal H corresponding to the turned-on switch 191.

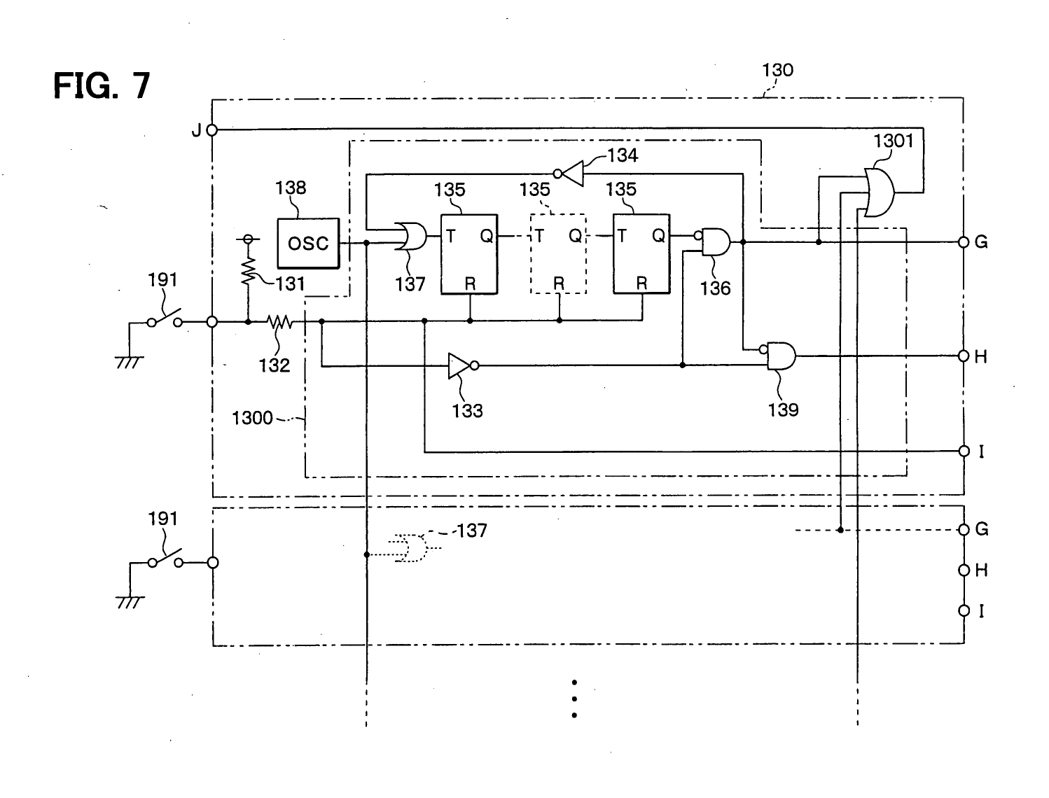

FIG. 7 is an example diagram of the control circuit 130. In the control circuit 130, control subcircuits 1300 are provided to the respective drive channels of the relays 20. The control subcircuit 1300 has a circuit configuration similar to that of the control circuit 60 shown in FIG. 2. The control subcircuit 1300 has resistors 131, 132, inverters 133, 134, counter circuits 135, AND-gates 136, 139 having one inverting input terminal and one non-inverting input terminal, and an OR-gate 137. An oscillator (OSC) 138 and an OR-gate 1301 having the same number of input terminals as the number of the control subcircuits 1300 are shared among all the control subcircuits 1300.

When the external input switch 191 is turned on, the control subcircuit 1300 outputs the high-level signal through the terminal G for the predetermined time period Ta. The output terminals of the inverter 133 and the AND-gate 136 are coupled to the non-inverting input terminal and the inverting input terminal of the AND-gate 139, respectively. Therefore, when the control subcircuit 1300 outputs the low-level signal through the terminal G after an elapse of the predetermined time period Ta, the control subcircuit 1300 outputs the high-level signal through the terminal H. The control subcircuit 1300 outputs the high-level signal through the terminal I as long as the external input switch 191 stays OFF. The output terminals of the AND-gates 136 of the respective control subcircuits 1300 are coupled to the input terminals of the OR-gate 1301, the output terminal of which is coupled to the terminal J. Therefore, when at least one of the secondary circuits 1300 outputs the high-level signal through the terminal G, the high-level signal is outputted from the terminal J.

Operations of the relay drive circuit 300 are described below, assuming that one of the relays 20 is driven, i.e., one of the drive channels operates.

When the external input terminal 191 is turned off, the control circuit 130 outputs a high-level signal through the terminal I, thereby turning on the relay-off circuit 170. Thus, the gate of the MOSFET 180 is grounded so that the MOSFET 180 is turned off. Therefore, the relay 20 is not energized.

In this state, when the external input switch 191 is turned on, the control circuit 130 outputs the low-level signal through the terminal I and the high-level signal through the terminals J, G, for the predetermined time period Ta. Therefore, the MOSFETs 111, 112 of the power supply switching circuit 110 and the initial energization circuit 150 are turned on. Thus, the MOSFET 180 is turned on so that an initial energization is performed such that the battery 10 provides the initial energizing voltage to the relay 20 through the power supply switching circuit 110 and the MOSFET 180. As a result of the initial energization, the relay contact is fully held in a closed position.

Then, after the predetermined time period Ta, the control circuit 130 outputs the low-level signal through the terminals J, G and the high-level signal through the terminal H. Therefore, the MOSFETs 111, 112 of the power supply switching circuit 110 are turned off and the low-holding energization circuit 160 is turned on. Thus, the low-holding energization is performed such that the power supply circuit 30 provides the constant current to the relay 20 through the MOSFET 180.

In this case, the constant current flowing through the MOSFET 180 is N times the reference constant current flowing through the MOSFET 122 of the reference current circuit 120. The N-times constant current flows through the relay 20 so that the relay contact 22 is held in a closed position, even after the initial energization is finished.

Each drive channel of the relay drive circuit of 300 operates in the same way.

The power supply circuit 30, the power supply switching circuit 110, and the reference current circuit 120 are shared among all the drive channels. Therefore, the circuit configuration can be simplified.

Each drive channel has a diode 141. The diodes 141 construct a diode OR circuit. The output of the diode OR circuit is provided to the feedback circuit 140. Using the diode OR circuit and the feedback circuit 140, the power supply circuit 30 monitors the voltages of the relays 20 and outputs the constant voltage based on the monitored voltages.

Specifically, the diode OR circuit detects the lowest potential of the relays 20 on the downstream sides. The feedback circuit 140 is an inverting amplifier circuit and inversely amplifies the detected lowest potential (voltage). When resistance of the relay coil 21 increases, the voltage of the relay coil 21 increases as a result of decrease in potential of the relay coil 21 on the downstream side. In the feedback circuit 140, the decreased voltage (potential) is inversely amplified so as to be an increased voltage (potential). Therefore, when the resistance of the relay coil 21 increases, voltage applied to the terminal E of the power supply circuit 30 increases.

Thus, in the relay drive circuit 300, the power supply circuit 30 outputs the constant voltage based on an increase in resistance of the relay coil 21. Further, power consumption and heat generation in the power supply circuit 30 and the MOSFET 180 as the relay drive section are reduced.

Alternatively, detecting ambient temperature of the relay coil 21 or a current flowing through the relay coil 21 may detect the increase in resistance of the relay coil 20.

The embodiments described above may be modified in various ways.

For example, the relay 20 may undergo a refresh energization such that the initial energization is regularly performed. In such an approach, the relay contact 22 may be more firmly held in a closed position and return to the closed position even if the relay contact 22 is opened due to troubles.

The predetermined time period Ta, for which the initial energization of the relay 20 is performed, may be fixed or variable in accordance with some conditions, as long as the relay contact 20 is fully held in a closed position within the period.

Various types of transistors may be used instead of the MOSFET and the bipolar transistor.

A microcomputer may be used for controlling the control circuits 60, 130 by software.

Such changes and modifications are to be understood as being within the scope of the present invention as defined by the appended claims.

What is claimed is:

1. A relay drive circuit for driving a relay having a relay coil and a relay contact, the relay drive circuit comprising:
a power supply circuit for producing a constant voltage from a power supply; and
a relay holding circuit that performs an initial energization such that a voltage of the power supply provides an initial energizing voltage to the relay until the relay contact is driven to a closed position when the relay is driven, and a holding energization such that the constant voltage provides a constant current to the relay to hold the relay contact in the closed position as long as the relay is driven.

2. A relay drive circuit for driving a relay having a relay contact, the relay drive circuit comprising:
a power supply circuit for producing a constant voltage from a power supply;
an initial energization circuit for performing an initial energization such that the power supply provides an initial energizing voltage to the relay to drive the relay contact to a closed position;
a holding energization circuit for performing a holding energization such that the constant voltage provides a constant current to the relay to hold the relay contact in the closed position; and
a control circuit for controlling the initial energization circuit and the holding energization circuit, wherein
the control circuit controls the initial energization circuit in such a manner that the initial energization circuit performs the initial energization for a predetermined time period when the relay is driven, and
the control circuit controls the holding energization circuit in such a manner that the holding energization circuit performs the holding energization as long as the relay is driven.

3. The relay drive circuit according to claim 2, wherein
the holding energization circuit includes a first transistor and a reference constant current circuit having a second transistor coupled to the first transistor to construct a current mirror circuit having a predetermined mirror ratio,
the constant current provided to the relay flows through the first transistor, and
the reference constant current circuit produces a reference constant current that flows through the second transistor so that the constant current provided to the relay becomes the mirror ratio times the reference constant current.

4. A relay drive circuit for driving a relay having a relay contact, the relay drive circuit comprising:
a power supply circuit for producing a constant voltage from a power supply;
an initial energization circuit for performing an initial energization such that the power supply voltage provides an initial energizing voltage to the relay to drive the relay contact to a closed position;
a holding energization circuit for performing a holding energization such that the constant voltage provides a constant current to the relay to hold the relay contact in the closed position;
a power supply switching circuit for switching between the power supply and the constant voltage; and
a control circuit for controlling the initial energization circuit, the holding energization circuit, and the power supply switching circuit, wherein
the control circuit controls the power supply switching circuit in such a manner that the power supply is selected when the initial energization is performed and the constant voltage is selected when the holding energization is performed, and
the control circuit controls the initial energization circuit in such a manner that when the relay is driven, the initial energization circuit performs the initial energization for the predetermined time period and the holding energization circuit performs the holding energization after the predetermined time period.

5. The relay drive circuit according to claim 4, further comprising:
a first transistor for energizing the relay, wherein
the initial energization circuit controls the first transistor to perform the initial energization, and
the holding energization circuit controls the first transistor to perform the low-holding energization.

6. The relay drive circuit according to claim 5, wherein
the holding energization circuit includes a reference constant current circuit having a second transistor coupled to the first transistor to construct a current mirror circuit having a predetermined mirror ratio, and
the reference constant current circuit produces a reference constant current that flows through the second transistor when the low-holding energization is performed so that the constant current provided to the relay becomes the mirror ratio times the reference constant current.

7. The relay drive circuit according to claim 1, wherein
the power supply circuit is a switching regulator circuit that has a transistor and produces the constant voltage by switching the transistor on and off rapidly.

8. The relay drive circuit according to claim 1, wherein
the power supply circuit adjusts the constant voltage in accordance with an information that indicates a resistance of the relay coil, and
when the information indicates an increase in the resistance of the relay coil, the power supply circuit increases the constant voltage.

9. The relay drive circuit according to claim 8, wherein
the information is a voltage of the relay coil, a current flowing through the relay coil, or an ambient temperature of the relay coil.

10. The relay drive circuit according to claim 1, wherein
the constant voltage of the power supply circuit is lower than the voltage of the power supply, and
the power supply circuit includes means for regulating the constant voltage variably with a resistance of the relay coil.

11. A relay drive method comprising:
providing an energizing voltage to a relay for a predetermined time period when a relay is driven;
stopping the energizing voltage after the relay is fully operated;
generating a constant voltage lower than a voltage of a power supply; and
providing a constant current from the constant voltage to hold an operation of the relay.

12. The method according to claim 11, further comprising:
detecting a resistance of the relay; and
regulating the constant voltage based on the detected resistance to keep the constant current at a fixed amount.
